(19) United States
(12) Patent Application Publication
(10) Pub. No.: US 2012/0063319 A1
(43) Pub. Date: Mar. 15, 2012

(54) METHOD FOR MANAGING PATHS BETWEEN A SOURCE NODE AND A DESTINATION NODE WITHIN THE DATA LINK LAYER, CORRESPONDING SOURCE NODE AND TABLE

(75) Inventors: Philippe Christin, Rennes (FR); Sinda Sahaly, Cesson Sevigne (FR)

(73) Assignee: FRANCE TELECOM, Paris (FR)

(21) Appl. No.: 13/322,022

(22) PCT Filed: May 25, 2010
(86) PCT No.: PCT/FR2010/051002

§ 371 Date: Nov. 22, 2011

(30) Foreign Application Priority Data
May 25, 2009 (FR) 0953417

(51) Int. Cl. H04L 12/26

(52) U.S. Cl. 370/235

(57) ABSTRACT

A method is provided for managing paths between at least one source node and at least one destination node within the link layer in a mesh communication network including a plurality of intermediate nodes. At a given moment, at least two separate paths between the source node and the destination node are defined for distributing streams to be transmitted between the source node and the destination node. The method includes the following steps that are carried out in the source node: allocating a stream identifier to the streams; associating information representing a stream category to the streams; allocating one of the paths to one of the streams while taking into account the stream identifier and the stream category information.

### CROSS-REFERENCE TO RELATED APPLICATIONS

This application is a Section 371 National Stage Application of International Application No. PCT/FR2010/051002, filed May 25, 2010, which is incorporated by reference in its entirety and published as WO 2010/136715 on Dec. 2, 2010, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the transmission of data flows between a source node and a destination node (known as unicast transmission) in a local area network, making it possible to define at least two communications paths or trajectories between the source node and the destination node.

More specifically, the disclosure pertains to the optimizing of the data link layer which is the second of the seven layers in the OSI (Open Systems Interconnection) model.

The disclosure finds application especially in home area networks, especially (but not exclusively) in multi-technology networks implementing for example Ethernet, Wi-Fi or PLC (power line communications) or again in small-sized professional networks.

### BACKGROUND OF THE DISCLOSURE

As a reminder, it may be recalled that the data link layer is interposed between the physical layer and the network layer. It provides for the transmission of frames between the nodes of a same network, in controlling especially the addressing and arbitration on the transmission medium implemented. It relies especially on the Media Access Control (MAC) sub layer. Each node of the network is identified by its MAC address.

Generally, in the data link layer, a single path is identified to set up the link between a source node and a destination node. This path is defined by a series of intermediate nodes through which the information must travel in transit to reach the destination node. Thus, all the flows or flows to be transmitted from a given source node to a given destination node follow the same path.

In the case of meshed networks, if it often possible to identify several paths to connect a source node to a destination node. In this case, in prior art systems, only one of the paths is selected and used for all the flows transmitted by the source node to the destination node at a given point in time. The second path can take over all the traffic in the event of the breakdown of the first link.

Among the prior art protocols, there is the known protocol called the “Spanning Tree” (or STP). This is a layer 2 (data link) protocol designed for switches or bridges enabling a loopless network topology in local area networks (LANs). This protocol is defined in the IEEE 802.1D standard. According to this protocol, the networks must have a single path between two points and must therefore propose a loopless topology. The STP protocol detects the loops if any and deactivates network links by blocking certain ports of a switch, to guarantee the uniqueness of the path between two nodes. Finally, it can be noted that the STP protocol is a centralized protocol (centralized through the use of a single root node).

Another prior art protocol is that of level 2 “forwarding” by destination. The forwarding tables are built on the basis of the destination. The choice of the best path is done through shortest-path algorithms (using hop count metrics or counting the number of intermediate nodes needed to reach the destination node).

These two prior art path selection techniques do not provide for any special solution in the event of an exchange of several distinct flows between a same source node and a same destination node. In every case, the different flows will take the same path since they are associated with the same destination.

In certain cases, for example if one or more flows are already being transmitted between the source node and the destination node, the transmission of an additional flow may be difficult for reasons of path overload.

For example, in the case of forwarding by destination, and if the metric used for the selection is a number of hops, then the link will get saturated when far too many pieces of data have to be transmitted and it will remain saturated until the end of transmission.

It has also been proposed to apply a metric that takes packet losses into account. In this case, in a situation of saturation or overload detected on a first path, all the flows will switch over to a second path, known as a backup path, which itself runs the risk of becoming saturated. There is then a phenomena of oscillation (switching of all the flows from one path to another) and therefore of major deterioration of the quality of service.

In the case of the “Spanning Tree” protocol, certain ports are blocked and the path between a source node and a destination node is, in every situation, a unique path. The frames or packets exchanged between two nodes must absolutely take the same path. Again, all the flows destined for the same destination and delivered by a same source node must follow the same path.

### SUMMARY

There is therefore need for a technique that makes it possible to overcome these drawbacks of prior art protocols for the data link layer.

An exemplary embodiment of the invention relates to a method for managing paths between at least one source node and at least one destination node, in the data link layer, in a mesh communications network comprising a plurality of intermediate nodes.

According to an embodiment of the invention, at a given instant, at least two distinct paths between said source node and said destination node are defined to distribute flows to be transmitted between said source node and said destination node, and the method implements the following steps in said source node:
allocating, to said flows, a flow identifier;
associating, with said flows, a piece of information representing a category of flow;
allocating one of said paths to one of said flows in taking account of said flow identifier and said piece of information on category of flow.

An embodiment of the invention therefore proposes to take account of a flow identifier and of the categories of flows, for example classes of service, to allocate one among several paths. The allocation of a path generally corresponds to the allocation of an output interface, or link, of the source node, corresponding to a first portion of the path, this portion being constituted by a series of intermediate nodes up to the destination node.

Thus, it is possible to allocate different paths to distinct categories of flows sent out by a source node and intended for a same destination node, and therefore to optimize the management of the load. This optimizing takes account especially of the categories of flows and for example of the categories of service such as voice or video “best effort”.

According to one particular embodiment, said step for allocating one of said paths to one of said flows also takes account of at least one possible prior allocation of one of said paths to at least one other flow.

Thus, if one of the paths is overloaded, or considered to be overloaded in administrative terms (with a threshold being crossed), an embodiment of the method can select a path other than the path selected when there is no overload. In this case especially, two flows transmitted by the source node to the destination node can use two different paths.

According to one particular aspect, said identifier allocated to said flows during said allocation step is unique in said network for a flow or for a group of linked flows.

This unique flow identifier in the network enables the simple and efficient management of the load, as the identifier can be communicated to all the nodes. In certain embodiments, a flow identifier can be allocated to a group of flows. For example, the sound and image of a video conference are two different flows, but it may be wished to allocated the same identifier to them in order be sure that they pass through the same path.

According to a first particular embodiment, said identifier can for example be obtained by the hashing of a set of pieces of data belonging to the group comprising an address of the source node, an address of the destination node, an identifier of a transport protocol for said flow, a source port of said transport protocol for said flow in said source node, a destination port of said transport protocol for said flow in said destination node.

This hashing operation consists in applying a mathematical function to create the digital watermark of a message, by converting a variably sized message into a fixed size code with a view to its authentication or its storage.

The address of the source node is for example the network address of the source node, i.e. the level 3 address of the source node. Similarly, the address of the destination node is for example the network address of the destination node. This embodiment is particularly appropriate for a hardware implementation where said function is computed more speedily than in the case of a software implementation.

According to a second particular embodiment, said identifier can be obtained by concatenation of bits extracted from at least two fields of at least one packet of said flow, containing at least one of the pieces of data belonging to the group comprising an address of the source node, an address of the destination code, an identifier of a transport protocol for said flow, a source port of said transportation protocol for said flow in said source node, a destination port for said transportation protocol for said flow in said destination node. This embodiment is adapted to software implementation because it is less penalizing in terms of the time taken to write the flow identifier for each frame.

These two embodiments guarantee the uniqueness of the identifier of the flow.

In one particular embodiment of the invention, said allocation step implements, for said source node, a table associating an output interface of said source node with a pair comprising an address of a destination node and a category of flow.

Said table can also associate, with each of said pairs, a piece of information representing the load for the output interface concerned. This piece of information representing the load can especially be a piece of binary information indicating a normal state (denoted for example by Default) or an overload state (denoted for example by Overload).

By consulting the table, it is thus possible to detect the fact that an output interface of the node is in a state of overload and that it is preferable to send a flow to be transmitted to another less overloaded interface.

According to one particular embodiment, the identifier of a flow allocated to one of said output interfaces is associated in said table with said output interface and with the pair associated with said output interface.

This identifier may be recorded for example in the field also storing the piece of information representing the load, or it may be recorded in a distinct field.

In one particular embodiment, said mesh network implements at least two types of communications media.

The method of an embodiment of the invention can indeed find application especially in multi-technology networks (using for example the Ethernet, Wi-Fi, PLC and other technologies). It can of course also be applied to mono-technology mesh networks implementing for example the Ethernet protocol.

According to one particular embodiment, the method comprises a step for reallocating one of said paths to at least one of said flows being transmitted, when the transmission of another flow on said path is terminated.

It is also possible to reallocate a preferred path when its load becomes lighter.

An embodiment of the invention also pertains to a computer program product recorded on a non-transitory computer-readable medium comprising program code instructions to execute the method for managing paths as described here above when it is executed by a processor.

An embodiment of the invention also pertains to a source node in a mesh communications network comprising a plurality of intermediate nodes. Said source node comprises means to define at least two distinct paths between said source node and a destination node of the network.

Such a source node comprises especially means for allocating, to at least one flow to be transmitted to said destination node, a flow identifier, means of associating, with said at least one flow, a piece of information representative of a category of flow, and means for allocating one of said paths to said at least one flow, in taking account of said flow identifier and said piece of information on category of flow.

An embodiment of the invention also pertains to a table stored in the memory of a source node able to transmit a flow of data to a destination node in a mesh communications network comprising a plurality of intermediate nodes. This table is noteworthy in that it can be used to define at least two distinct paths between said source node and said destination node. According to an embodiment of the invention, such a table associates an output interface of said source node, corresponding to one of said at least two paths, with a data pair, an address of a destination node and a category of flow.

### BRIEF DESCRIPTION OF THE DRAWINGS

Other features and advantages shall appear more clearly from the following description of a particular embodiment, given by way of a simple, illustratory and non-exhaustive example, and from the appended drawings of which:

FIG. 1 gives a simplified illustration of an example of a multi-path network implementing an embodiment of the invention;

FIG. 2 is a simplified block diagram describing the different steps of the method of an embodiment of the invention;

FIG. 3 is another example of a network implementing an embodiment of the invention;

FIG. 4 provides a schematic illustration of a structure of a source node according to an embodiment of the invention.

### DETAILED DESCRIPTION OF ILLUSTRATIVE EMBODIMENTS

An embodiment of the invention therefore proposes a novel approach to the transmission of flows in the data link layer (level 2 of the OSI system) adapted to the mesh network, enabling the definition of several paths between a source node and a destination node. In particular, it may be a meshed Ethernet network or a multi-technology network, the nodes of which have at least two distinct interfaces, capable for example of respectively managing the Ethernet protocol, a Wi-Fi transmission or transmission by power link communications (PLC).

According to an embodiment of the invention, a solution is proposed enabling the management of multiple paths in the data link layer to distribute if necessary the flows to be transmitted between a source node A and a destination node B, especially as a function of their category.

The category of a flow may be a class of service representing the type of its content (video, audio). It may simply take into account a level of importance or of priority.

Thus, the method for managing according to an embodiment of the invention implements chiefly the following steps:
associating, with a flow to be transmitted to the destination node, a piece of information representing a category of flow;
allocating a portion of one of the paths to a flow, in taking account of the information representing a category of flow.

The allocation of one path or another in the network therefore takes account especially of this category.

Besides, depending on the embodiment presented, each flow is allocated an identifier, herein called “Flow-ID” so as to perform optimized forwarding for each flow (and no longer as in the prior art, forwarding solely to destination). Thus, this forwarding can take account on the one hand of the category, or class of service, and on the other hand of the load of each path.

In other words, the embodiment discussed enables forwarding, in the data link layer, by destination, by category, or class of service, by flow and by load.

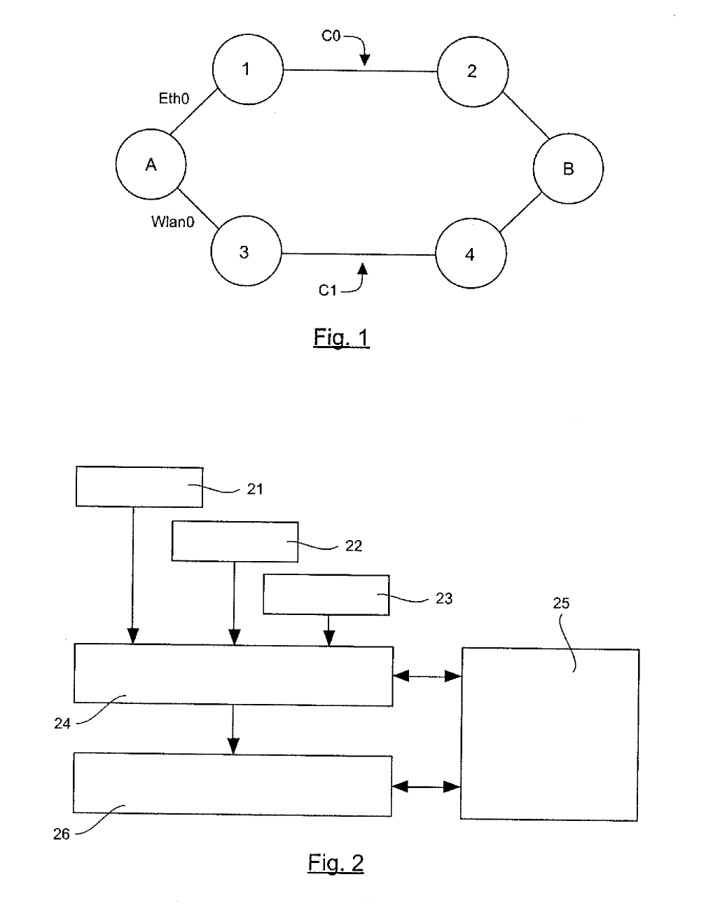

FIG. 1 illustrates a simplified example of a multi-technological mesh network implementing the method of an embodiment of the invention. The exchanges between the source node A and an address node (destination node) B must be considered. This node A can communicate with the node B by two paths C0 (“path 0”) or C1 (“path 1”) respectively supported by the two output interfaces, respectively Eth0 and Wlan0.

The path C0 travels through two intermediate nodes 1 and 2, for example according to the Ethernet protocol, at least for the first portion between the node A and the node 1. Seen from the node A, the path C0 is associated with its output interface Eth0 and therefore with the first portion of the path C0 connecting the node A to the node 1. The rest of the transfer, on the portions connecting the node 1 to the node 2 and then the node 2 to the node B is controlled respectively by the nodes 1 and 2 in a manner known per se.

The path C1 comprises the intermediate nodes 3 and 4 which are interconnected to each other in using Wi-Fi technology, at least for the first portion of the path C1 between the node A and the node 3. Seen from the node A, the path C1 is associated with its output interface Wlan0 and therefore with the first portion of the path C1 connecting the node A to the node 3. The subsequent part of the transfer is done in a classic way by the nodes 3 and 4.

Thus, unlike in the prior art techniques for the data link layer, which provide a single path for the transmission of all the flows that have to be transmitted by the node A to the node B, an embodiment of the invention makes it possible to choose the paths C0 or the path C1 selectively as a function especially of the category of flow considered.

For example, it could be decided that the path C0, called a nominal path, is preferably intended for each category and the that path C1, called a backup path, is allocated when the load of the nominal path is in excess according to a predetermined overload determining criterion as explained here below. In this case, the choice of one path or another shall be done as a function on the one hand of the category of the flow and on the other hand of the load of the path.

According to another approach, it can be planned that the path C0 will be the default path for at least one first category whereas a second category, making fewer demands, could be content by default with the second path, although it performs less well.

To implement the first approach, it is planned to associate a flow number (Flow-ID) with each flow. This makes it possible to manage the routing of two flows independently for the same destination, with the same category as the case may be, and therefore makes it possible to allocate two different paths to them if necessary.

To this end, each source node manages, for each destination node, a forwarding table generically constituted, when the topology of the network is initialized, when there are no flows.

In another embodiment of the invention, the steps of the method of management described here above are (also) implemented in the intermediate nodes. Thus, all the nodes of the network, provided they are capable of sending (and therefore of transmitting) implement the steps of the method described here above.

An example of an initial forwarding table for the node A of the network of FIG. 1 is illustrated here below. This initial table is built during the initialization of the network, when there is no flow to be transmitted.

TABLE 1
Initial forwarding table of the node A

| | Service | Path | | |
|---|---|---|---|---|
| Destination | Class | Metric | Flow usage | Output interface |
| MAC @ B | Best Effort | 0 | Default | Eth0 |
| MAC @ B | Voice | 0 | Default | Wlan0 |
| MAC @ B | Video | 0 | Default | Eth0 |
| MAC @ B | Best Effort | 1 | Default | Wlan0 |
| MAC @ B | Voice | 1 | Default | Eth0 |
| MAC @ B | Video | 1 | Default | Wlan0 |

The first column includes the destination address. In the example of FIG. 1, only one destination (the node B) is planned. In the real cases, several other destination nodes could be identified, and the necessary rows could be added accordingly in the table.

The second column indicates the different classes of service or categories of flows. In the present example, three categories have been identified:
“Best Effort”, for the flows of lowest priority;
“Voice”, for the voice flows;
“Video”, for the video or multimedia flows.

It is of course possible, without departing from the framework of the invention, to define other categories or, on the contrary, to limit their number to two.

The third column “path metric” associates a metric that characterizes the quality of the path in question.

The first three entries, or rows, of the table define the nominal paths (metric at 0 (the value zero herein being the greatest value)) for the three classes of service. The following three entries define the backup paths (metric at 1).

If there were to be more than two output interfaces available, the table would include additional rows for each other interface.

Besides, it can be planned that the nominal path for a particular category will not be the same as for another category.

The fourth column “Flow usage” indicates especially the state of load of the next portion of the path considered. In the embodiment illustrated, it could have two values, “Default” or “Normal” and “Overload”.

The fifth column, “output interface” specifies the path that has to be used for each entry.

An example of the updating of this table shall now be described.

If the node A must send a first “Best effort” type flow that is addressed to the node B and to which the flow number 11 has been allocated, then the field “Flow usage” is updated with the number of this flow, as illustrated in the following table.

In another approach, an additional column can be planned to record these flow numbers in the table.

TABLE 2
First updating of the “forwarding” table of the node A

| | Service | Path | | |
|---|---|---|---|---|
| Destination | class | metric | Flow usage | Output interface |
| MAC @ B | Best Effort | 0 | Default-11 | Eth0 |
| MAC @ B | Voice | 0 | Default | Wlan0 |
| MAC @ B | Video | 0 | Default | Eth0 |
| MAC @ B | Best Effort | 1 | Default | Wlan0 |
| MAC @ B | Voice | 1 | Default | Eth0 |
| MAC @ B | Video | 1 | Default | Wlan0 |

This flow 11 will therefore be transmitted on the nominal path Eth0. So long as this path or link is not saturated, any other flow of this “Best effort” category will be conveyed by using this default input.

If the node A must additionally send the packets of a video flow number 12 to the node B, then the field “Flow Usage” of the third entry is updated with the flow number 12 as illustrated here below.

TABLE 3
Second updating of the “forwarding” table of the node A

| | Service | Path | | |
|---|---|---|---|---|
| Destination | Class | metric | Flow usage | Output Interface |
| MAC @ B | Best Effort | 0 | Overload-11 | Eth0 |
| MAC @ B | Voice | 0 | Default | Wlan0 |
| MAC @ B | Video | 0 | Overload-12 | Eth0 |
| MAC @ B | Best Effort | 1 | Default | Wlan0 |
| MAC @ B | Voice | 1 | Overload | Eth0 |
| MAC @ B | Video | 1 | Default | Wlan0 |

The link Eth0 then reaches saturation because of the transmission of the flows 11 and 12. The field “Flow usage” is updated accordingly: all the inputs of the table having the interface Eth0 as the output interface are marked as saturated (“Overload”).

Such saturation can be detected reactively, the regular updating of the m metrics enabling the detection of the deterioration of the path in question and making it possible to declare it as being saturated. It can also be detected proactively: the crossing of the preliminarily configured load threshold means that the output interface can be considered to be saturated.

If a new video flow 35 arrives, the source node will scan this “forwarding” table and note that the nominal path is saturated. It will therefore decide to use the backup path (Path 1) for this flow 35.

Thus, as illustrated in the table below, the flow 35 will be transmitted through the backup path Wlan0 and the flow number will be recorded in the corresponding field.

TABLE 4
Third updating of the “forwarding” table of the node A

| | Service | Path | | |
|---|---|---|---|---|
| Destination | class | metric | Flow usage | Output interface |
| MAC @ B | Best Effort | 0 | Overload-11 | Eth0 |
| MAC @ B | Voice | 0 | Default | Wlan0 |
| MAC @ B | Video | 0 | Overload-12 | Eth0 |
| MAC @ B | Best Effort | 1 | Default | Wlan0 |
| MAC @ B | Voice | 1 | Overload | Eth0 |
| MAC @ B | Video | 1 | Default-35 | Wlan0 |

The video flow 35 will be transmitted by the second path while the flows 11 and 12 are transmitted by the first path. It can be seen therefore that the flows coming from the same source node and intended for the same destination node can be split up or distributed on several paths so as to benefit from the resources offered by the network.

FIG. 2 is a schematic illustration of the main steps of the method of an embodiment of the invention.

According to a first step 21, a flow number called a “Flow-ID” is associated with each flow. This flow number is computed by the source node and encoded in a field of the protocol header of each frame. It is unique in the level 2 network considered.

It can be computed for example by hashing several pieces of data (in the case of a hardware implementation) such as the address of the source node, the address of the destination node, an identifier of the transport protocol of the flow, the source port of the transport protocol of the flow in the source node, the destination port of the transport protocol for the flow in the destination node, etc.

According to another approach, it can be computed by concatenation of bits extracted from different fields of the IP and TCP/UDP headers (this is the case of a software implementation). These fields can especially comprise at least one of the pieces of data belonging to the group comprising an address of the source node, an address of the destination code, an identifier of a transport protocol for said flow, a source port of said transport protocol for said flow of said source node, a destination port of said protocol transport of said flow in said destination node.

This flow identifier or flow number is encoded for example on two bytes (16 bits) and is unique in the network.

This flow number enables the selection of the path by the nodes of the network to be done no longer on the basis only of the destination address and the category of flow but also in taking account of the flow number and, in the embodiment under discussion, on the triplet (destination, class of service, flow number).

Indeed, in a second step 22, a class of service or category is associated with each flow.

Depending on three pieces of information which are the destination address 23, the class of service and the flow number, a step 24 for allocating a path is used to decide the path allocated to the flow considered, in referring to table 25, according to the approach described here above.

More specifically, the step 24 identifies the output interface, or port, of the source node which must be used (for example Eth0 or Wlan0) and therefore the portion of a path connecting the source node to the closest intermediate node in the path considered.

The table 25 is updated as a function of this allocation 24, according to the process described further above.

It is also possible to provide for a path reallocation step 26 in taking account of the modification of the load of a path, for example when the transmission of one of the flows is terminated. In this case, if the “Flow Usage” field corresponding to the nominal path (or more generally a path that is preferred over the one currently used) returns to the “default” state for a given category, then a flow of this category preliminarily transmitted on the backup path can be transferred to the nominal path.

This reallocation can be implemented when an end of transmission of flow is detected or more generally can be implemented periodically. Indeed, the “forwarding” tables are classically updated regularly, for example every 100 milliseconds.

Indeed, each node must necessarily exchange these pieces of information on forwarding with its neighboring nodes to enable routing up to the destination node.

This updating and these exchanges can use for example the IS-IS (Intermediate System to Intermediate System) protocol which is a link-state forwarding protocol used to maintain a common topological view.

FIG. 3 illustrates another example of a network, comprising two neighboring source nodes A and C both liable to send out flows to the destination node B in using the same intermediate nodes 1 and 3.

The node 1, the “forwarding” table of which is presented here below, includes three Ethernet interfaces, Eth0, Eth1 and Eth2, respectively connected to the nodes A, C and 2.

It is important to note that, in this case, the management of the load of each link or path takes account of the flows sent out by each of the two nodes A and C. Thus, should the node C have to send a video flow 17, while the operation is in the situation illustrated in the table 2, the flow number 17 will appear in the forwarding table of the intermediate node 1 supplied by the source nodes A and C as illustrated here below.

TABLE 5
Updating of the forwarding table of the node 1.

| | Service | Path | | |
|---|---|---|---|---|
| Destination | Class | metric | Flow usage | Output Interface |
| MAC @ B | Best Effort | 0 | Overload-11 | Eth2 |
| MAC @ B | Voice | 0 | Default | Eth2 |
| MAC @ B | Video | 0 | Overload-17 | Eth2 |
| MAC @ B | Best Effort | 1 | Default | Eth1 |
| MAC @ B | Voice | 1 | Default | Eth1 |
| MAC @ B | Video | 1 | Default | Eth1 |
| MAC @ B | Best Effort | 2 | Default | Eth0 |
| MAC @ B | Voice | 2 | Default | Eth0 |
| MAC @ B | Video | 2 | Default | Eth0 |

The path allocation in the node A will therefore be the same when the video flow 35 arrives when the video flow 12 was transmitted by the node A. In other words, the fact that the video flows 12 or 17 are sent by the node A or by another node, as it happens the node C for the flow 17, is of no importance for the choice of the output interface, but the pieces of information provided by the table are different from those of table 4. This is possible, in this embodiment, because of the link-state protocol disseminates the state of overload or saturation of the link 1-2 through a high metric (set at 10 in the table 6 here below).

If the link between the nodes 1 and 2 gets saturated, the nodes A and C will detect it through a deterioration of the metrics, and adapt the allocation accordingly.

TABLE 6
Updating of the forwarding table of the
node A with the flows 11, 17 and 35

| | Service | Path | | |
|---|---|---|---|---|
| Destination | class | metric | Flow usage | Output interface |
| MAC @ B | Best Effort | 0 | Default-11 | Eth0 |
| MAC @ B | Voice | 0 | Default | Wlan0 |
| MAC @ B | Video | 10 | Default | Eth0 |
| MAC @ B | Best Effort | 1 | Default | Wlan0 |
| MAC @ B | Voice | 1 | Default | Eth0 |
| MAC @ B | Video | 1 | Default-35 | Wlan0 |

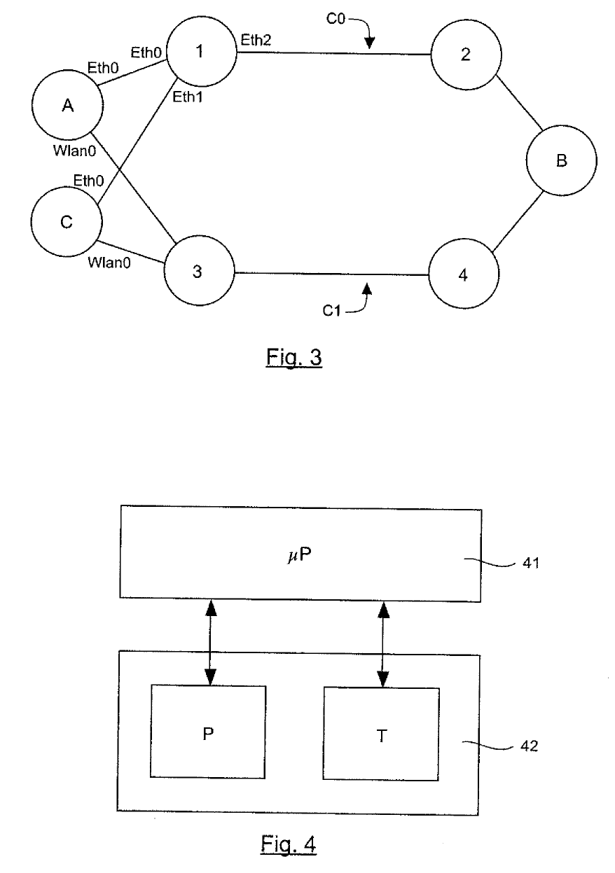

FIG. 4 schematically illustrates a source node implementing an embodiment of the invention. It is driven by a microprocessor μp 41, which communicates with a memory 42 containing especially the forwarding table T. This memory 42, or as the case may be another memory, also contains the program P making it possible to drive the microprocessor 41 and implementing the steps of the method described here above.

In particular, it updates the table as a function of the flows that it must send and the information that it receives from the neighboring nodes in the network.

Although the present disclosure has been described with reference to one or more examples, workers skilled in the art will recognize that changes may be made in form and detail without departing from the scope of the disclosure and/or the appended claims.

1. A method for managing paths between at least one source node and at least one destination node, at the data link layer, in a mesh communications network comprising a plurality of intermediate nodes, wherein, at a given instant, at least two distinct paths between said source node and said destination node are defined to distribute flows to be transmitted between said source node and said destination node, and wherein said method implements the following steps in said source node:
allocating, to said flows, a flow identifier;
associating, with said flows, a piece of information representing a category of flow; and
allocating one of said paths to one of said flows in taking account of said flow identifier and said piece of information on category of flow.

2. The method for managing paths according to claim 1, wherein said step of allocating one of said paths to one of said flows also takes account of at least one possible prior allocation of one of said paths to at least one other flow.

3. The method for managing paths according to claim 1, wherein said identifier allocated to said flows during said allocation step is unique in said network, for a flow or for a group of linked flows.

4. The method for managing paths according to claim 3, wherein said identifier is obtained by hashing of a set of pieces of data belonging to the group consisting of an address of the source node, an address of the destination node, an identifier of a transport protocol for said flow, a source port of said transport protocol for said flow in said source node, a destination port of said transport protocol for said flow in said destination node.

5. The method for managing paths according to claim 3, wherein said identifier is obtained by concatenating bits extracted from at least two fields of at least one packet of said flow, containing at least one of the pieces of data belonging to the group consisting of an address of the source node, an address of the destination code, an identifier of a transport protocol for said flow, a source port of said transportation protocol for said flow in said source node, a destination port for said transportation protocol for said flow in said destination node.

6. The method for managing paths according to claim 1, wherein said step of allocating implements, for said source node, a table associating an output interface of said source node with a pair comprising an address of a destination node and a category of flow.

7. The method for managing paths according to claim 6, wherein said table associates, with each of said pairs, a piece of information representing the load for the associated output interface.

8. The method for managing paths according to claim 7, wherein said piece of information representing the load comprises a piece of binary information indicating a normal state or an overload state.

9. The method for managing paths according to claim 6, wherein the identifier of a flow allocated to one of said output interfaces is associated in said table with said output interface and with the pair associated with said output interface.

10. The method for managing paths according to claim 1, wherein said mesh network implements at least two types of communications media.

11. The method for managing paths according to claim 2, wherein the method comprises a step of reallocating one of said paths to at least one of said flows being transmitted, when the transmission of another flow on said path is terminated.

12. A computer program product comprising program code instructions recorded on a non-transitory computer-readable medium to execute a method of managing paths between at least one source node and at least one destination node, at the data link layer, in a mesh communications network comprising a plurality of intermediate nodes, when the instructions are executed by a processor, wherein, at a given instant, at least two distinct paths between said source node and said destination node are defined to distribute flows to be transmitted between said source node and said destination node, and wherein said method implements the following steps in said source node:
allocating, to said flows, a flow identifier;
associating, with said flows, a piece of information representing a category of flow; and
allocating one of said paths to one of said flows in taking account of said flow identifier and said piece of information on category of flow.

13. A source node in a mesh communications network comprising a plurality of intermediate nodes, wherein the source node comprises:
means for defining at least two distinct paths between said source node and a destination node,
means for allocating, to at least one flow to be transmitted to said destination node, a flow identifier,
means for associating, with said at least one flow, a piece of information representative of a category of flow, and
means for allocating one of said paths to said at least one flow, in taking account of said flow identifier and said piece of information on category of flow.

14. A table stored in a memory of a source node able to transmit a flow of data to a destination node in a mesh communications network comprising a plurality of intermediate nodes, wherein the table associates an output interface of said source node, corresponding to one of at least two distinct paths defined between said source node and said destination node, with a data pair, an address of a destination node and a category of flow.
